(19) United States
(12) Patent Application Publication
(10) Pub. No.: US 2020/0295356 A1
(43) Pub. Date: Sep. 17, 2020

(54) PROCESS FOR PRODUCING SEMICONDUCTOR NANOWIRES AND CARBON/SEMICONDUCTOR NANOWIRE HYBRID MATERIALS

(71) Applicant: Nanotek Instruments, Inc., Dayton, OH (US)

(72) Inventors: Aruna Zhamu, Springboro, OH (US); Yanbo Wang, Miamisburg, OH (US); Bor Z. Jang, Centerville, OH (US)

(73) Assignee: Nanotek Instruments, Inc., Dayton, OH (US)

(21) Appl. No.: 16/298,199

(22) Filed: Mar. 11, 2019

(51) Int. Cl. H01M 4/36; H01M 10/0525; H01M 4/587; H01M 4/38

(52) U.S. Cl. CPC H01M 4/366; H01M 10/0525; H01M 2004/027; H01M 4/38; H01M 4/387; H01M 4/587

(57) ABSTRACT

This disclosure provides a process for producing carbon-semiconductor nanowire hybrid material, comprising: (A) preparing a catalyst metal-coated mixture mass, which includes mixing carbon filaments with micron or sub-micron scaled semiconductor particles to form a mixture and depositing a nanoscaled catalytic metal onto surfaces of the carbon filaments and/or semiconductor particles; and (B) exposing the catalyst metal-coated mixture mass to a high temperature environment (preferably from 100° C. to 2,500° C.) for a period of time sufficient to enable a catalytic metal-catalyzed growth of multiple semiconductor nanowires using the semiconductor particles as a feed material to form the carbon-semiconductor nanowire hybrid material composition. An optional etching or separating procedure may be conducted to remove catalytic metal or carbon filaments from the semiconductor nanowires.

### FIELD

The disclosure herein relates to a process for producing semiconductor nanowires or carbon/semiconductor nanowires for lithium-ion battery anode applications.

### BACKGROUND

Lithium ion battery is a prime candidate energy storage device for electric vehicle (EV), renewable energy storage, and smart grid applications. Graphite materials have been widely used as an anode active material for commercial lithium ion batteries due to their relatively low cost and excellent reversibility. However, the theoretical lithium storage capacity of graphite is only 372 mAh/g (based on LiC₆), which can limit the total capacity and energy density of a battery cell. The emerging EV and renewable energy industries demand the availability of rechargeable batteries with a significantly higher energy density and power density than what the current Li ion battery technology can provide. Hence, this requirement has triggered considerable research efforts on the development of electrode materials with higher specific capacity, excellent rate capability, and good cycle stability for lithium ion batteries.

Several elements from Group III, IV, and V in the periodic table can form alloys with Li at certain desired voltages. Therefore, various anode materials based on such elements (e.g. Si, Ge, Sn, Sb, etc.), their compounds, and some metal oxides (e.g., SnO₂) have been proposed for lithium ion batteries. Among these, silicon is considered the most promising one since it has the highest theoretical specific capacity (up to 4,200 mAh/g in the stoichiometric form of Li_{4.4}Si) and low discharge potential (i.e., high operation potential when paired with a cathode).

However, using Si as an example, the dramatic volume changes (up to 380%) of Si during lithium ion alloying and de-alloying (cell charge and discharge) often led to severe and rapid battery performance deterioration. The performance fade is mainly due to the volume change-induced pulverization of Si and the inability of the binder/conductive additive to maintain the electrical contact between the pulverized Si particles and the current collector. In addition, the intrinsically low electric conductivity of silicon and other semiconductor materials is another challenge that needs to be addressed. Thus far, many attempts have been made to improve the electrochemical performance of Si-based anode materials, which include (1) reducing particle size to the nanoscale (<100 nm), such as Si nanoparticles, nanowires, or thin film, to reduce the total strain energy, which is a driving force for crack formation in the particle; (2 ) depositing Si particles on a highly electron-conducting substrate; (3) dispersing Si particles in an active or non-active matrix; and (4) coating Si particles with a layer of carbon. Although some promising anodes with specific capacities in excess of 1,000 mAh/g (at a low charge/discharge rate; e.g. 0.1 C) have been reported, it remains challenging to retain such high capacities over cycling (e.g., for more than 100 cycles) without significant capacity fading. Furthermore, at a higher C rate, Si particles and other high-capacity anode active material (Ge, Sn, etc.) are typically incapable of maintaining a high lithium storage capacity. It may be noted that a rate of n C means completing the charge or discharge cycle in 1/n hours: 0.1 C=10 hours, 0.5 C=2 hours, 3C=⅓ hours or 20 minutes.

Although nanoscaled anode active materials, such as Ge nanoparticles, Si nanowires, and Sn nano films, are promising high-capacity anode materials, these materials remain too expensive to be economically viable. Again, using Si as an example, common methods used for producing silicon nano powders include plasma-enhanced chemical vapor deposition (PECVD), laser-induced pyrolysis of SiH₄, and hot-wire synthesis methods. From mass production and cost perspectives, current processes for producing nano Si powder have been time-consuming and energy-intensive, also typically requiring the use of high-vacuum, high-temperature, and/or high-pressure production equipment. The resulting Si nano powder products have been extremely expensive and this cost issue has severely impeded the full-scale commercialization of Si nano powder materials. Hence, there exists a strong need for a more cost-effective process for producing Si nano powder (e.g. Si nanowires or nano particles) in large quantities.

For instance, U.S. Pat. No. 7,615,206 issued on Nov. 10, 2009 to K. H. Sandhage and Z. H. Bao provides methods for the production of shaped nanoscale-to-microscale silicon through partially or completely converting a nanoscale-to-microscale silica template by using magnesium vapor. Magnesiothermic reduction of silica requires much lower temperatures (normally in the range from 600° C.-800° C.) compared with the carbothermal reduction of silica (normally over 2000° C.) and thus has become a relatively popular technique used in pure metal production. Silicon is obtained by the following reaction: 2Mg+SiO₂→2MgO+Si. However, this process must be conducted under a high pressure condition and there is the danger of explosion not just during the reaction procedure (due to pressure vessel weakness), but also after the reaction is presumably completed when the reactor is opened (ultra-fast reaction of un-used Mg with air). Furthermore, when using Mg vapor to chemically reduce silica, magnesium silicide could be easily formed and, hence, this process is not suitable for mass production. Using magnesium powder will add to cost of producing nano sized silicon and the particle size of magnesium could dramatically influence the reduction results and purity.

Herein, we present a facile and cost-effective method of mass-producing semiconductor nanowires. This method avoids all the problems commonly associated with conventional methods of producing nanoscaled semiconductor materials.

### SUMMARY

This disclosure provides a process for producing a carbon/semiconductor nanowire hybrid material composition; the process comprising: (A) preparing a catalyst metal-coated mixture mass, which includes mixing carbon filaments having a diameter or thickness from 10 nm to 30 μm, with micron or sub-micron scaled semiconductor particles, having a particle diameter from 50 nm to 50 μm, to form a mixture and depositing a catalytic metal, in the form of nano particles having a size from 1 nm to 100 nm (preferably less than 50 nm, more preferably less than 10 nm, and further preferably less than 5 nm, and most preferably 1-2 nm) or a coating having a thickness from 1 nm to 100 nm (preferably less than 50 nm, more preferably less than 10 nm, and further preferably less than 5 nm, and most preferably 1-2 nm), onto surfaces of said carbon filaments and/or surfaces of the semiconductor particles, wherein the semiconductor material (including some metalloid elements) is selected from Si, Ga, In, Ge, Sn, Pb, P, As, Sb, Bi, Te, a compound thereof, an alloy thereof, or a combination thereof; and (B) exposing the catalyst metal-coated mixture mass to a high temperature environment, from 100° C. to 2,500° C., for a period of time sufficient to enable a catalytic metal-assisted growth of multiple semiconductor nanowires, having a diameter or thickness from 2 nm to 100 nm, from the semiconductor particles to form the carbon-semiconductor nanowire hybrid material composition.

The compounds of these semiconductor materials include the III-VI compounds (e.g. InP, GaAs, GaP, etc.) and oxides, borides, carbides, nitrides of these elements, such as GaN,

The carbon filaments may be selected from carbon nanotubes, carbon nanofibers, graphite nanofibers, graphene fibers, carbon fibers, graphite fibers, carbon black chains, or a combination thereof. In some preferred embodiments, the carbon filaments have a diameter from 10 nm to 200 nm or a specific surface area from 50 m²/g to 1,500 m²/g.

In certain embodiments, carbon filaments form a fabric, nonwoven, paper, membrane, or foam structure having pores and the catalytic metal-coated semiconductor particles reside in the pores and wherein the catalytic metal nano particles or coating is deposited on pore wall surfaces.

In certain embodiments, the catalytic metal (including metalloid) is selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof, wherein the catalytic metal is different than the semiconductor material. Preferably, a catalytic metal and its pairing semiconductor material form a eutectic point in the phase diagram.

The starting micron or sub-micron scaled semiconductor particles can have a diameter from 0.2 μm to 50 μm, but preferably from 0.5 μm to 5 μm, and more preferably <3 μm.

The starting semiconductor particles and starting carbon filaments, referred to as primary particles, may be mixed to produce secondary particles, which are each a mixture of carbon filaments, semiconductor particles, and possibly other ingredients (e.g. conductive additive). In an embodiment, the carbon filaments and micron or sub-micron scaled semiconductor particles are mixed to form a mixture in a particulate form of multiple secondary particles having a size from 1 μm to 30 μm.

In one embodiment, the starting carbon filaments and micron or sub-micron scaled semiconductor particles are mixed to form a mixture prior to the step of depositing a catalytic metal on surfaces of carbon filaments and/or surfaces of semiconductor particles. This mixture is preferably prepared in a particulate form, characterized by having the two primary particles (carbon filaments and semiconductor particles) combined to form secondary particles having a diameter from 1 μm to 100 μm, preferably from 2 μm to 50 μm, and more preferably from 5 μm to 20 μm. The carbon filament/semiconductor mixture can optionally contain an amount (e.g. 1% to 30% by weight) of conductive additive for the mere purpose of enhancing the electrical or thermal conductivity of the resulting battery electrode. The conductive additive may be selected from natural graphite, artificial graphite, mesophase carbon, mesophase pitch, mesocarbon microbead, soft carbon, hard carbon, coke, or a combination thereof.

The step of mixing the semiconductor particles and carbon filaments may be conducted by liquid solution mixing, homogenizer mixing, high shearing mixing, wet milling, air milling, or ball-milling.

In an alternative embodiment, the mixing of carbon filaments with micron or sub-micron scaled semiconductor particles is conducted after surfaces of the carbon filaments and/or the semiconductor particles are deposited with the catalytic metal. The mixing of carbon filaments with micron or sub-micron scaled semiconductor particles is conducted in such a manner that the resulting mixture is in a form of porous secondary particles having a diameter from 1 μm to 20 μm and having pores therein from 2 nm to 1 μm in size.

In certain embodiments, in the disclosed process, the step of depositing a catalytic metal includes (a) dissolving or dispersing a catalytic metal precursor in a liquid to form a precursor solution, (b) bringing the precursor solution in contact with surfaces of the carbon filaments and/or semiconductor particles, (c) removing the liquid component; and (d) chemically or thermally converting the catalytic metal precursor to the catalytic metal coating or metal nano particles. In one embodiment, the step (d) of chemically or thermally converting the catalytic metal precursor is conducted concurrently with the procedure (B) of exposing the catalyst metal-coated mixture mass to a high temperature environment.

In the process, the step (d) of chemically or thermally converting the catalytic metal precursor may be conducted concurrently with the procedure (B) of exposing the catalyst metal-coated mixture mass to a high temperature environment.

In certain embodiments, the catalytic metal precursor is a salt or organo-metal molecule of a metal (including metalloid) selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, Ge, Si, or a combination thereof. The catalytic metal includes not only metal elements but also metalloid elements, such as Al, Ge, Si, Sb, Sn, and Ti.

In some preferred embodiments, the catalytic metal precursor is selected from a nitrate, acetate, sulfate, phosphate, hydroxide, or carboxylate of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

In some embodiments, the catalytic metal precursor is selected from a nitrate, acetate, sulfate, phosphate, hydroxide, or carboxylate of a transition metal.

The step (B) of exposing the catalyst metal-coated semiconductor material to a high temperature environment is preferably conducted in steps, including at least at a lower temperature (first temperature) for a first period of time and then at a higher temperature (second temperature) for a second period of time. These temperatures can include a first temperature from 100° C. to 1,000° C. and a second temperature from300° C. to 2,500° C. The heat treatment at the first temperature is mainly aimed at reducing the metal precursor (e.g. a metal salt) to a metal phase or to activate the metal coated on semiconductor material. The heat treatment at the second temperature is aimed at building a thermodynamic environment conducive to initiation and growth of semiconductor nanowires from the semiconductor particles. It may be noted that the required high temperature range depends on the catalytic metal used, given the same semiconductor material.

In certain embodiments, the semiconductor material and the pairing catalytic metal form an eutectic point in the phase diagram and the procedure of exposing the catalyst metal-coated semiconductor material to a high temperature environment includes exposing the material to a temperature equal to or higher than the eutectic point for a desired period of time and then bringing the material to a temperature below the eutectic point. In some embodiments, the exposure temperature is higher than the eutectic temperature by 0.5 -500 degrees in Celsius scale (preferably by 1-100 degrees centigrade).

These semiconductor nanowires appear to have extruded out from the starting semiconductor particles and emanate from a center of the semiconductor particle. The semiconductor nanowires produced in this manner typically have a diameter less than 100 nm and a length-to-diameter aspect ratio of at least 5 (more typically l/d=10-10,000 and most typically 100-1,000).

In an embodiment, the step of depositing a catalytic metal on surfaces of the semiconductor particles and carbon filaments includes (a) dissolving or dispersing a catalytic metal precursor in a liquid to form a precursor solution, (b) bringing said precursor solution in contact with surfaces of semiconductor particles and carbon filaments, (c) removing the liquid; and (d) chemically or thermally converting said catalytic metal precursor to said catalytic metal coating or nano particles. The step (d) of chemically or thermally converting the catalytic metal precursor is conducted concurrently with the procedure (B) of exposing the catalyst metal-coated materials to a high temperature environment.

Preferably, the catalytic metal precursor is a salt or organo-metal molecule of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof. Examples of the precursors include copper nitrate, nickel nitrate, cobalt nitrate, manganese nitrate, iron nitrate, titanium nitrate, aluminum nitrate, copper acetate, nickel acetate, cobalt acetate, manganese acetate, iron acetate, titanium acetate, aluminum acetate, copper sulfate, nickel sulfate, cobalt sulfate, manganese sulfate, iron sulfate, titanium sulfate, aluminum sulfate, copper phosphate, nickel phosphate, cobalt phosphate, manganese phosphate, iron phosphate, titanium phosphate, aluminum phosphate, copper hydroxide, nickel hydroxide, cobalt hydroxide, manganese hydroxide, iron hydroxide, titanium hydroxide, aluminum hydroxide, copper carboxylate, nickel carboxylate, cobalt carboxylate, manganese carboxylate, iron carboxylate, titanium carboxylate, aluminum carboxylate, or a combination thereof.

The catalytic metal (including metalloid) is preferably selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof. They can be produced from the aforementioned precursors. Alternatively, the deposition of catalytic metal can be accomplished more directly. Thus, in an embodiment, the step of depositing a catalytic metal is conducted by a procedure of physical vapor deposition, chemical vapor deposition, sputtering, plasma deposition, laser ablation, plasma spraying, ultrasonic spraying, printing, electrochemical deposition, electrode plating, electrodeless plating, chemical plating, ball milling, or a combination thereof.

The procedure of exposing the catalyst metal-coated materials to a high temperature environment may be conducted in a protective atmosphere of an inert gas, nitrogen gas, hydrogen gas, a mixture thereof, or in a vacuum.

The presently disclosed process may further comprise a procedure of removing the catalytic metal from the carbon/semiconductor nanowires hybrid after the nanowires are produced; for instance, via chemical etching, electrochemical etching, density difference-based sedimentation or centrifuging, etc.

The process may further comprise a procedure of mixing semiconductor nanowires with a carbonaceous or graphitic material (as a conductive additive) and an optional binder material to form a battery electrode layer, wherein the carbonaceous or graphitic material is selected from a chemical vapor deposition carbon, physical vapor deposition carbon, amorphous carbon, chemical vapor infiltration carbon, polymeric carbon or carbonized resin, pitch-derived carbon, natural graphite, artificial graphite, mesophase carbon, mesophase pitch, mesocarbon microbead, soft carbon, hard carbon, coke, carbon fiber, carbon nanofiber, carbon nanotube, carbon black, or a combination thereof.

The disclosure also provides a process for producing a carbon/semiconductor nanowire hybrid material composition wherein the semiconductor nanowires have a diameter or thickness from 2 nm to 100 nm, the process comprising: (a) preparing a precursor mixture of semiconductor particles (having a size from 50 nm to 100 μm) and carbon filaments, wherein the semiconductor is selected from Si, Ga, In, Ge, Sn, Pb, P, As, Sb, Bi, Te, a compound thereof, an alloy thereof, or a combination thereof; (b) depositing a catalyst metal precursor onto surfaces of the semiconductor particles and carbon filaments to form a catalyst metal precursor-coated material mixture; and (c) exposing the catalyst metal precursor-coated material mixture to a high temperature environment, from 100° C. to 2,500° C., for a period of time sufficient to convert the catalyst metal precursor to a metal catalyst in the form of nano particles having a size from 1 nm to 100 nm or a coating having a thickness from 1 nm to 100 nm in physical contact with the semiconductor particles and carbon filaments, and enable a catalyst metal-assisted growth of multiple semiconductor nanowires from the semiconductor particles. It is essential that the catalyst metal nano particles coating are in physical contact with the semiconductor particles and carbon filaments, preferably deposited on surfaces of both the semiconductor particles and carbon filaments.

In certain preferred embodiments, the semiconductor material and the catalyst metal form an eutectic point step (c) of exposing the catalyst metal precursor-coated semiconductor material to a high temperature environment includes exposing the material to an exposure temperature equal to or higher than the eutectic point for a desired period of time and then bringing the material to a temperature below this exposure temperature for a desired period of time or at a desired temperature decreasing rate.

The disclosure also provides a battery electrode containing semiconductor nanowires (with or without the carbon filaments) that are produced by the disclosed process. Also provided is a lithium battery containing semiconductor nanowires produced by the disclosed process as an anode active material.

### BRIEF DESCRIPTION OF THE DRAWINGS

FIG. 1(A) A flow chart showing a preferred route to preparing semiconductor nanowires (2-100 nm) from particles of the same semiconductor material, having a diameter from 50 nm to 100 μm; using Ge as an example.

FIG. 1(B) Another flow chart showing a preferred route to preparing semiconductor nanowires from particles of the same semiconductor material, having a diameter from 50 nm to 100 μm, using Ge as an example.

FIG. 2 Phase diagram of the Bi—Sn system.

FIG. 3 Phase diagram of the Al—Ge system.

FIG. 4(A) SEM image of Si nanowires grown from Si particles without the presence of carbon nano materials, such as CNTs, and CNFs.

FIG. 4(B) SEM image of Si nanowires grown from Si particles with the presence of CNFs.

FIG. 5 SEM image of Ge nanowires.

FIG. 6(A) SEM image of Sn nanowires.

FIG. 6(B) SEM image of Sn nanowires grown in the presence of CNTs.

FIG. 7 The effect of Ge nanowire diameter on the rate capability of an anode active material in a lithium-ion battery.

FIG. 8 The charge/discharge cycling behaviors of two lithium-ion cells, one featuring Sn nanowires grown in situ inside graphene sheet/CNF-protected particulates as the anode active material and the other containing a simple mixture of Sn nanowires and graphene sheets/CNFs.

### DETAILED DESCRIPTION OF PREFERRED EMBODIMENTS

The disclosure provides a process for producing a carbon/semiconductor nanowire hybrid material composition. In certain embodiments, the process comprises: (A) preparing a catalyst metal-coated mixture mass, which includes mixing carbon filaments (having a diameter from 5 nm to 30 μm) with micron or sub-micron scaled semiconductor particles, having a particle diameter from 50 nm to 50 μm, to form a mixture and depositing a catalytic metal, in the form of nano particles having a size from 1 nm to 100 nm or a coating having a thickness from 1 nm to 100 nm, onto surfaces of the carbon filaments and/or surfaces of the semiconductor particles, wherein the semiconductor material is selected from Si, Ga, In, Ge, Sn, Pb, P, As, Sb, Bi, Te, a compound thereof, an alloy thereof, or a combination thereof; and (B) exposing the catalyst metal-coated mixture mass to a high temperature environment, from 100° C. to 2,500° C., for a period of time sufficient to enable a catalytic metal-assisted growth of multiple semiconductor nanowires, having a diameter or thickness from 2 nm to 100nm, from the semiconductor particles to form the carbon-semiconductor nanowire hybrid material composition. The compounds of these semiconductor materials include the III-VI compounds (e.g. InP, GaAs, GaP, etc.) and oxides, borides, carbides, nitrides of these elements, such as GaN.

The disclosure provides a process for initiating and growing semiconductor nanowires from micron or sub-micron scaled semiconductor particles having an original particle diameter (prior to nanowire growth) from 50 nm to 500 μm (preferably from 100 nm to 20 μm). In other words, the starting material is micron or sub-micron scaled semiconductor particles, which are thermally and catalytically converted directly into nanoscaled, wire-shaped structures having a diameter or thickness from 2 nm to 100nm. Carbon filaments play a key role in promoting the growth of a larger number of smaller-diameter semiconductor nanowires (more typically from 2 to 35 nm) relative to the growth of semiconductor nanowires from semiconductor particles alone without the presence of carbon filaments (typically having a diameter from 10nm to 100 nm and more typically from 35 to 90 nm).

A wide variety of carbon filaments may be implemented for use in practicing the disclosure. Preferably, carbon filaments are selected from carbon nanotubes, carbon nanofibers, graphite nanofibers, graphene fibers, carbon fibers, graphite fibers, carbon black chains, or a combination thereof.

Carbon nanotubes (CNTs) may contain single-walled CNTs and/or multi-walled CNTs. Carbon nanofibers (CNFs) may include vapor-grown CNFs and/or those obtained from carbonization of polymer nanofibers (e.g. electron-spun polymer nanofibers carbonized at a temperature from 300 to 2,000° C.). Graphite nanofibers are obtained by graphitization of carbon nanofibers at a temperature from 2,500 to 3,200° C. Graphene fibers include those fibers obtained by wet-spinning of graphene sheets or graphene oxide sheets. Graphene fibers are structurally distinct from graphene sheets. Carbon fibers and graphite fibers include those conventional fibers, typically having a diameter from 3 μm to 30 μm, obtained from polyacrylonitrile (PAN), pitch, rayon, cellulose fibers, etc. Carbon black chains include the chains of carbon black nanoparticles, acetylene black nanoparticles, and the like. These nanoparticles tend to aggregate together to form chains of particles.

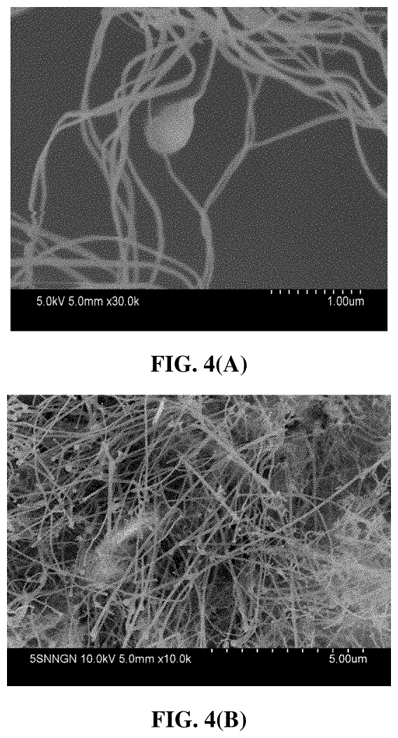

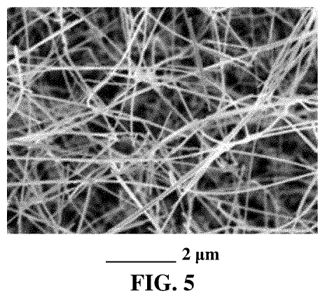

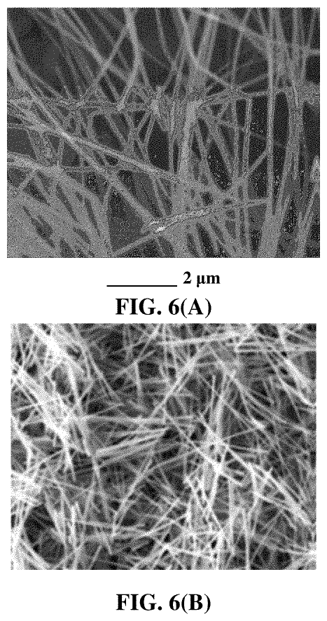

Studies using scanning electron microscopy (SEM) indicate that tens of nanowires can be grown or “extruded out” from a starting solid semiconductor particle. As an example, FIG. 4(A) shows that tens of Si nanowires have been sprouted or emanated from each Si particle that was originally 2-5 μm in diameter. These Si nanowires have drawn the needed Si atoms from the few starting Si particles. By spitting out a large number of nanowires, the original Si particles, if smaller than 2 μm in diameter, were fully expended. When larger particles having an original diameter >3 μm were used, there were typically some residual Si particles left. By spitting out such a large number of nanowires, the original Si particles (without the help from graphene sheets) were reduced to approximately 0.6 μm in diameter. With the presence of carbon filaments having a high specific surface area, essentially all the micron or sub-micron Si particles are totally “eaten”; there is typically no residual Si particles left and there are a huge number of finer Si nanowires produced (e.g. FIG. 4(B). SEM images of Ge nanowires and Sn nanowires are shown in FIG. 5 and FIGS. 6(A) & 6(B), respectively.

There are several advantages associated with this process. For instance, there is no chemical reaction (such as converting SiH₄ into Si in a CVD process) and the process does not involve any undesirable chemical, such as silane, which is toxic. There is no danger of explosion, unlike the process of converting GeO₂ to Ge or SiO₂ to Si using magnesium vapor. Other additional advantages will become more transparent later.

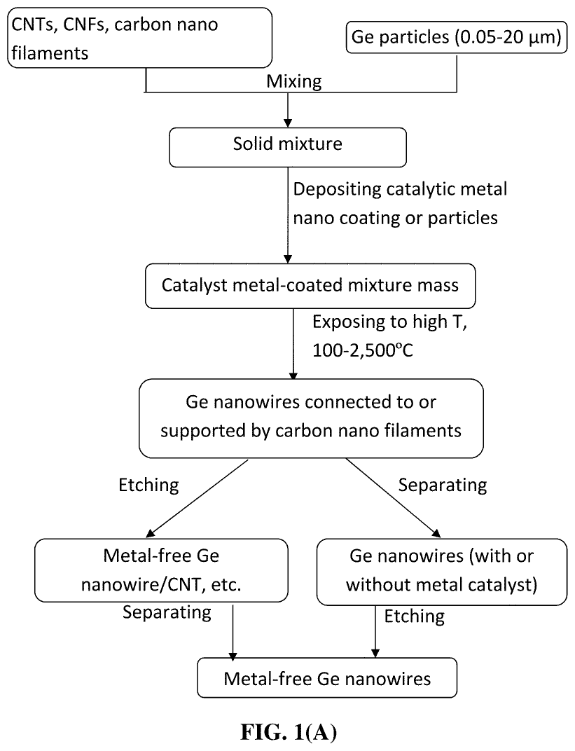

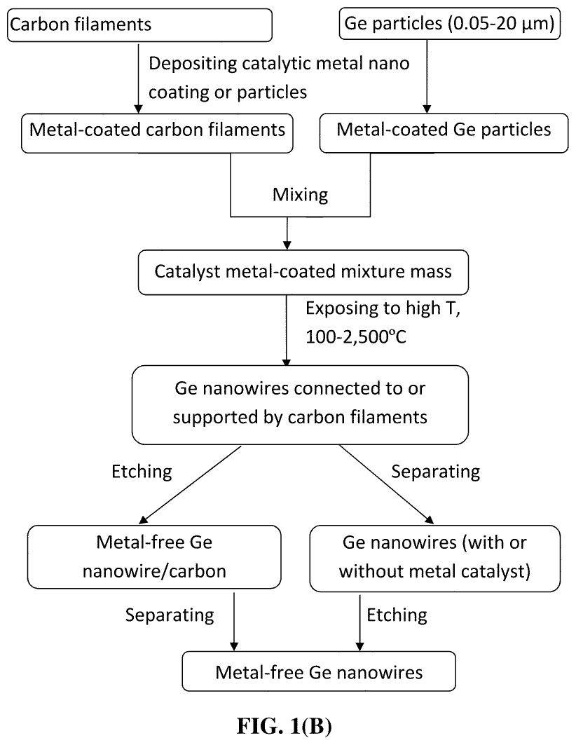

As illustrated in FIGS. 1(A) and 1(B), this process begins by preparing a catalyst metal-coated mixture mass (Procedure A), which includes (a) mixing carbon filaments (having a diameter from 10nm to 30 μm) with micron or sub-micron scaled semiconductor particles to form a mixture and (b) depositing a catalytic metal onto surfaces of the carbon filaments and/or surfaces of the semiconductor particles. The step (a) of mixing and step (b) of catalyst metal deposition can occur sequentially (i.e. (a) after (b), or (b) after (a)), or concurrently. Preferably, the carbon filaments are positioned to have as many contact spots with semiconductor particles as possible. This can be accomplished by wrapping semiconductor particles with carbon filaments.

The catalytic metal is preferably in the form of a nanoscaled coating (having a thickness less than 100 nm, preferably less than 50 nm, more preferably less than 10 nm, and further preferably less than 5 nm, and most preferably 1-2 nm) or nanoscaled particles (having a diameter less than 100 nm, preferably less than 50 nm, more preferably less than 10 nm, and further preferably less than 5 nm, and most preferably 1-2 nm). Thinner metal coating or smaller particles of metal are more effective in producing a larger number of smaller semiconductor nanowires, which are preferred features when it comes to using semiconductor nanowires as an anode active material of a lithium-ion battery.

In Procedure B, the catalyst metal-coated mixture mass is then exposed to a high temperature environment (preferably from 100° C. to 2,500° C., more preferably from 200° C. to 1,500° C., and most preferably and typically from 300° C. to 1,200° C.) for a period of time sufficient to enable a catalytic metal-catalyzed growth of multiple semiconductor nanowires. These semiconductor nanowires are emanated or extruded out from the semiconductor particles, which act as the source material for the growing semiconductor nanowires to feed on. Additionally, even larger numbers of semiconductor nanowires are emanated from surfaces of carbon filaments. This is most striking because there was no semiconductor material pre-deposited on surfaces of carbon filaments. The resulting mass is a hybrid material composed of carbon filaments and semiconductor nanowires (possibly plus residual metal nano particles). The semiconductor nanowires have a diameter from 1 nm to 100 nm (more typically 2-20 nm) and a length that is typically 1-1000 μm (more typically 10-30 μm); hence, a length-to-diameter aspect ratio more typically from 10 to 10,000 (most typically from 100 to 1,000).

The starting semiconductor particles preferably have a diameter from 100 nm to 10 μm, more preferably <3 μm. The starting semiconductor particles are preferably spherical, cylindrical, or platelet (disc, ribbon, etc.) in shape, but can be of any shape. Semiconductor particles of various shapes and various particle sizes are commercially available.

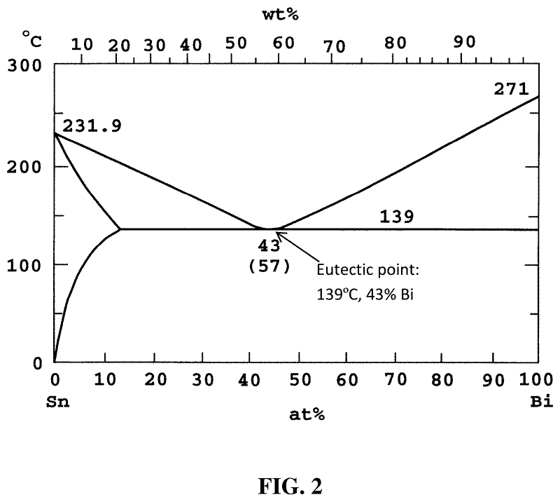

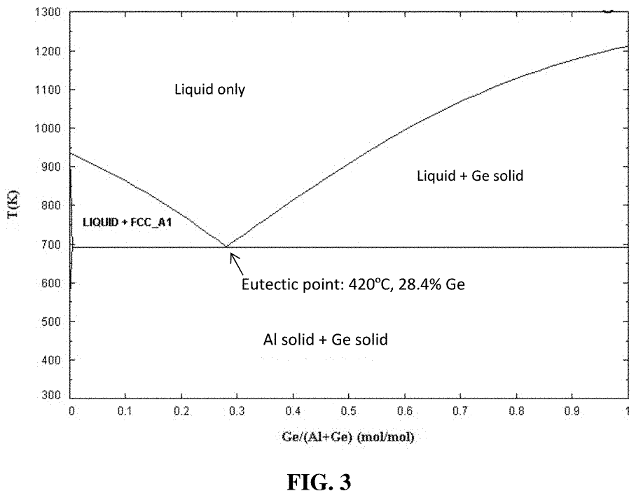

It may be noted that this high temperature range depends on the catalytic metal used. Two examples are used herein to illustrate the best mode of practice. Shown in FIG. 2 and FIG. 3 are phase diagrams of the Sn—Bi and Ge—Al system, respectively. In the first example, Sn is the semiconductor material and Bi is the catalyst metal and, in the second example, Ge is the semiconductor and Al is the catalyst metal.

In the Sn—Bi binary system, there exists a eutectic point at a eutectic temperature Te=139° C. and eutectic composition Ce=46% (atomic percentage of Bi). A mass of Bi-coated Sn particles and Bi-coated carbon filaments may be slowly heated to above Te (e.g. a high temperature from 139.5° C. to 230° C., lower than both the melting temperature of the semiconductor, 231.9° C., and the melting temperature of the catalyst metal, 271° C.). The heating rate can be from 1 to 100 degrees/min (centigrade scale). One can allow the Bi-coated Sn particles and carbon filaments to stay at this high temperature (say 170° C.) for 1 minute to 3 hours and then cool the material down to 145° C. (slightly above Te) and/or even 135° C. (slightly below Te) for 1-180 minutes. This will lead to the formation of Sn nanowires from the coated Sn particles.

In the Ge—Al binary system, there exists a eutectic point at a eutectic temperature Te=420° C. and eutectic composition Ce=71.6% (atomic percentage of Al). A mass of Al-coated Ge particles and carbon filaments may be slowly heated to above Te (e.g. a high temperature from 421° C. to 600° C., lower than both the melting temperature of the semiconductor, 938.2° C., and the melting temperature of the catalyst metal, 660.3° C.). The heating rate can be from 1 to 100 degrees/min (centigrade scale). One can allow the Al-coated Ge particles and carbon filaments to stay at this high temperature (say 460° C.) for 1 minute to 3 hours and then cool the material down to 430° C. (slightly above Te) and/or even 415° C. (slightly below Te) for 1-180 minutes. This will lead to the formation of Ge nanowires from the coated Sn particles. Alternatively, one may choose to cool the materials slowly down from 460° C. (after staying at this temperature for a desired period of time) to room temperature.

In some embodiments, the step of depositing a catalytic metal includes: (a) dissolving or dispersing a catalytic metal precursor in a liquid to form a precursor solution; e.g. dissolving nickel nitrate, Ni(NO₃)₂, in water; (b) bringing the precursor solution in contact with surfaces of semiconductor particles and carbon filaments; e.g. immersing the particles/filaments into the Ni(NO₃)₂-water solution; (c) removing the liquid component; e.g. vaporizing water of the Ni(NO₃)₂-water solution, allowing Ni(NO₃)₂ to coat on the surfaces of the semiconductor particles and carbon filaments; and (d) chemically or thermally converting the catalytic metal precursor (e.g. Ni(NO₃)₂) to the catalytic metal coating or metal nano particles; e.g. by heating the Ni(NO₃)₂-coated mass at 450-650° C. in a reducing environment (e.g. in a flowing gas mixture of hydrogen and argon).

In one embodiment, the step (d) of chemically or thermally converting the catalytic metal precursor is conducted concurrently with the step of exposing the catalyst metal-coated semiconductor particles and graphene sheets or exfoliated graphite flakes to a high temperature environment.

In certain embodiments, the catalytic metal precursor is a salt or organo-metal molecule of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

In some preferred embodiments, the catalytic metal precursor is selected from a nitrate, acetate, sulfate, phosphate, hydroxide, or carboxylate of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

In some embodiments, the catalytic metal precursor is selected from a nitrate, acetate, sulfate, phosphate, hydroxide, or carboxylate of a transition metal. In certain embodiments, for instance, the catalytic metal precursor is selected from copper nitrate, nickel nitrate, cobalt nitrate, manganese nitrate, iron nitrate, titanium nitrate, aluminum nitrate, copper acetate, nickel acetate, cobalt acetate, manganese acetate, iron acetate, titanium acetate, aluminum acetate, copper sulfate, nickel sulfate, cobalt sulfate, manganese sulfate, iron sulfate, titanium sulfate, aluminum sulfate, copper phosphate, nickel phosphate, cobalt phosphate, manganese phosphate, iron phosphate, titanium phosphate, aluminum phosphate, copper carboxylate, nickel carboxylate, cobalt carboxylate, manganese carboxylate, iron carboxylate, titanium carboxylate, aluminum carboxylate, or a combination thereof. Given the same semiconductor particles, different types of precursor require different temperatures and/or chemical reactants for conversion to the catalytic metal phase. Different catalytic metals enable semiconductor nanowire growth at different temperatures.

The step of depositing a catalytic metal may also be conducted by a procedure of physical vapor deposition (PVD), chemical vapor deposition (CVD), sputtering, plasma deposition, laser ablation, plasma spraying, ultrasonic spraying, printing, electrochemical deposition, electrode plating, electrodeless plating, chemical plating, ball milling, or a combination thereof.

The step of mixing the semiconductor particles and graphene sheets is conducted by liquid solution mixing, homogenizer mixing, high shearing mixing, wet milling, air milling, or ball-milling.

In an alternative embodiment, the mixing of carbon filaments with micron or sub-micron scaled semiconductor particles is conducted after surfaces of the carbon filaments and/or the semiconductor particles are deposited with the catalytic metal. This can be accomplished by using the above-described solution deposition procedure (i.e. dissolving nickel nitrate, copper acetate, etc. in a liquid, followed by liquid removal). Alternatively, ultra-thin coating or nano particles of a catalytic metal may be deposited on the surfaces of semiconductor particles and carbon filaments using sputtering, physical vapor deposition, chemical vapor deposition, laser ablation, etc.

The mixing of metal-coated carbon filaments with metal-coated micron or sub-micron scaled semiconductor particles is conducted in such a manner that the resulting mixture is in a form of porous secondary particles having a diameter from 1 μm to 20 μm and having pores therein from 2 nm to 1 μm in size.

The procedure of exposing the catalyst metal-coated mixture mass to a high temperature environment is preferably conducted in a protective or reducing atmosphere of an inert gas, nitrogen gas, hydrogen gas, a mixture thereof, or in a vacuum.

It may be noted that the present process appears to enable semiconductor nanowires to grow from both original semiconductor particle surfaces and surfaces of carbon filaments. A highly unexpected observation is the notion that a huge number of semiconductor nanowires appear to grow out of surfaces of carbon filaments as well. These semiconductor nanowires appear to emanate from these carbon filament surfaces everywhere, even though that there was no pre-deposited semiconductor material on these surfaces and there were limited initial contact points between carbon filaments and original semiconductor particles (i.e. there was very limited amount of semiconductor on carbon filament surfaces). With the presence of carbon filaments, the number of semiconductor nanowires is typically 1 or 2 orders of magnitude larger than that in the samples containing semiconductor particles alone, without the presence of metal-coated carbon filaments. Additionally, the resulting semiconductor nanowires are significantly smaller in diameter, typically thinner than 35 nm (more typically from 2 nm to 20 nm), in contrast to the typically >35 nm (more typically >50 nm and most typically >60 nm) for those semiconductor nanowires grown directly from original semiconductor particles. These are highly desirable attributes considering that smaller semiconductor nanowire diameters imply shorter diffusion paths for lithium ions and, hence, faster charge and discharge procedures for the lithium-ion batteries.

Typically, in the resulting hybrid material, multiple carbon filaments and catalytic metals are present along with the produced semiconductor nanowires. For certain applications, one may choose to use semiconductor nanowires without g carbon filaments. Hence, in an embodiment, the process may further comprise a procedure of separating the carbon filaments from the semiconductor nanowires.

In one embodiment, the process may further comprise a procedure of removing the residual catalytic metal from the semiconductor nanowires; for instance, via chemical etching or electrochemical etching.

In a desired embodiment, the process of producing semiconductor nanowires is followed by a procedure of incorporating a carbonaceous or graphitic material into the mass of multiple semiconductor nanowires as a conductive additive in the preparation of an anode electrode. This carbonaceous or graphitic material may be selected from a chemical vapor deposition carbon, physical vapor deposition carbon, amorphous carbon, chemical vapor infiltration carbon, polymeric carbon or carbonized resin, pitch-derived carbon, natural graphite, artificial graphite, mesophase carbon, mesophase pitch, mesocarbon microbead, soft carbon, hard carbon, coke, carbon fiber, carbon nanofiber, carbon nanotube, carbon black, or a combination thereof.

For instance, multiple semiconductor nanowires may be readily packed into a porous membrane or mat (with or without a small amount of resin binder), which may be impregnated or infiltrated with carbon under a chemical vapor deposition (CVD) or chemical vapor infiltration condition. This may be accomplished by introducing methane or ethylene gas into the system at a temperature of 500° C.-1,500° C. Alternatively, one may impregnate the porous semiconductor nanowire membrane with a resin or pitch, which is then heated to carbonize the resin or pitch at a temperature of 350° C.-1,500° C. Alternatively, one may simply blend semiconductor nanowires with particles of a carbon or graphite material with an optional binder resin to form a multi-component mixture.

In one preferred embodiment of the disclosure, the porous web can be made by using a slurry molding or a flake spraying technique. These methods can be carried out in the following ways:

As a wet process, aqueous slurry is prepared which comprises a mixture of carbon filaments and a desired amount of micron or sub-micron semiconductor particles. A water solution of metal salt may also be added to the slurry. The slurry is then directed to impinge upon a sieve or screen, allowing water to permeate through, leaving behind filaments/particles. The slurry may also be sprayed dried to form secondary particles containing carbon filaments, semiconductor particles, and catalytic metal salt (if present) coated on surfaces of semiconductor and carbon filaments.

As a dry process, the directed filament-wire spray-up process utilizes an air-assisted spraying gun, which conveys filaments/particles to a molding tool (e.g., a perforated metal screen shaped identical or similar to the part to be molded). Air goes through perforations, but the solid components stay on the molding tool surface.

Each of these routes can be implemented as a continuous process. For instance, the process begins with pulling a substrate (porous sheet) from a roller. The moving substrate receives a stream of slurry (as described in the above-described slurry molding route) from above the substrate. Water sieves through the porous substrate with all other ingredients (a mixture of carbon filaments, optional conductive fillers, and semiconductor particles) remaining on the surface of the substrate being moved forward to go through a compaction stage by a pair of compaction rollers. Heat may be supplied to the mixture before, during, and after compaction to help cure the thermoset binder (if present) for retaining the shape of the resulting web or mat. The web or mat, with all ingredients held in place by the thermoset binder, may be stored first (e.g., wrapped around a roller). Similar procedures may be followed for the case where the mixture is delivered to the surface of a moving substrate by compressed air, like in a directed fiber/binder spraying process. Air will permeate through the porous substrate with other solid ingredients trapped on the surface of the substrate, which are conveyed forward. The subsequent operations are similar than those involved in the slurry molding route.

Other processes that can be used to produce mixtures of semiconductor particles and carbon filaments include, for instance, spray drying of slurry containing the mixture, wet milling, ball milling, impact milling, tumbling drying, freeze-drying, etc.

In a desired embodiment, the process of producing a carbon filament-semiconductor nanowire hybrid material composition further comprises a procedure of incorporating a carbonaceous or graphitic material into the carbon filament-semiconductor nanowire hybrid material composition as a conductive additive. This carbonaceous or graphitic material is selected from a chemical vapor deposition carbon, physical vapor deposition carbon, amorphous carbon, chemical vapor infiltration carbon, polymeric carbon or carbonized resin, pitch-derived carbon, natural graphite, artificial graphite, mesophase carbon, mesophase pitch, mesocarbon microbead, soft carbon, hard carbon, coke, carbon fiber, carbon nanofiber, carbon nanotube, carbon black, or a combination thereof.

For instance, the carbon filament-semiconductor nanowire hybrid material composition, in a porous membrane form, may be impregnated or infiltrated with carbon under a chemical vapor deposition (CVD) or chemical vapor infiltration condition. This may be accomplished by introducing methane or ethylene gas into the system at a temperature of 500° C.-1,500° C. Alternatively, one may impregnate the porous carbon filament-semiconductor nanowire hybrid material composition with a resin or pitch, which is then heated to carbonize the resin or pitch at a temperature of 350° C.-1,500° C. Alternatively, one may simply mix the particulates of carbon filament-semiconductor nanowire hybrid material composition with particles of a carbon or graphite material to form a multi-component mixture.

The following examples are provided for the purpose of illustrating modes of practicing the present invention and should not be construed as limiting the scope of the instant invention. The selection of the following semiconductor materials as examples is based on the consideration that they have a high specific capacity when used as an anode active material: Li₄Si (3,829 mAh/g), Li_{4.4}Ge (1,623 mAh/g), Li_{4.4}Sn (993 mAh/g), and Li₃Sb (660 mAh/g).

### EXAMPLE 1

### Preparation of CNT Porous Paper/Mats Containing Ge Particles and/or Metal Salt

A desired amount of Ge particles were then added into suspensions (CNTs in surfactant-containing water) to form a slurry samples. These slurry samples were then filtered through a vacuum-assisted membrane filtration apparatus to obtain porous layers (membranes) of CNT/Ge paper or mat. These mat/paper membranes were then impregnated with a solution of nickel nitrate, iron nitrate, and copper acetate in water. Water was subsequently removed from the impregnated membranes and the dried membranes were then exposed to a reducing atmosphere of H₂ and Ar gas following a desired temperature profile, typically from room temperature to a reduction temperature of approximately 300° C.-700° C. (for reduction of nickel nitrate to Ni nano coating, for instance). The temperature was continued to rise to a final temperature of 762° C.-900° C. for 3 hours and the system was allowed to cool down naturally. Ge nanowires were found to emanate from both existing Ge particles and CNT surfaces. The diameter of the Ge nanowires was observed to be from approximately 21 nm to 37 nm.

### COMARATIVE EXAMPLE 1a

### Nickel-Assisted Growth of Ge Nanowires from Ge Particles

Ge particles were immersed in a solution of nickel nitrate or nickel acetate in water. Water was subsequently removed and the dried particles were coated with a thin layer of nickel nitrate or nickel acetate. These metal precursor-coated Ge particles were then exposed to a heat treatment in a reducing atmosphere of H₂ and Ar gas according to a desired temperature profile. This profile typically included from room temperature to a reduction temperature of approximately 300° C.-700° C. (for reduction of nickel nitrate or acetate to Ni nano coating, for instance). The temperature was continued to rise to a final temperature of 762° C.-900° C. for 3 hours and the system was allowed to cool down naturally. Nickel metal catalyst-assisted growth of Ge nanowires from Ge particles was found to occur. The diameter of Ge nanowires produced was in the range from 47 nm to 77 nm.

### EXAMPLE 2

### Preparation of Porous CNF Mats to Support/Promote Growth of Nanowires

Vapor-grown carbon nanofibers were added into de-ionized water to form a suspension having a solid content of approximately 1.5% by weight in a container. A desired amount of aluminum sulfate was dissolved in water to form a metal salt solution. The metal salt solution was then added into the CNF suspension, followed by addition of Ge particles to form slurry samples. The slurries were then cast onto a glass surface. The resulting CNF/Ge/metal salt films, after removal of liquid, have a thickness that can be varied from approximately 10 to 500 μm. The resulting CNF/Ge/metal salt compact was then subjected to heat treatments at a temperature of 400° C.-650° C. for 1-5 hours. This heat treatment concurrently accomplishes three things: reduction of Al metal salt to Al metal nano coating, formation of pores (2 nm-10 μm) due to evolution of volatile reaction product species (e.g. CO₂, H₂O, etc.), and catalytic growth of Ge nanowires from Ge particles and CNF surfaces.

As a baseline experiment, we have also prepared a slurry containing Ge particles (but no CNFs) in water with a corresponding metal salt dissolved therein. This was followed by casting and heat-treating under comparable conditions for comparison purposes.

In each sample containing CNFs, a huge number of Ge nanowires appear to have grown out of CNF surfaces. These Ge nanowires appear to emanate from everywhere on these surfaces. With the presence of CNFs, the number of Ge nanowires is typically 1 or 2 orders of magnitude larger than that in the samples containing Ge particles alone, without the presence of CNFs.

Additionally, the resulting Ge nanowires emanated from graphene surfaces are significantly smaller in diameter, typically thinner than 35 nm (more typically 18-33 nm), in contrast to the typically >35 nm for those Ge nanowires grown directly from original Ge particles. Nanowires having a smaller diameter are more high-rate capable, being able to deliver a higher specific capacity when the lithium-ion battery is charged or discharged.

### EXAMPLE 3

### Copper-Assisted Growth of Sb Nanowires from Sb Particles and Porous Carbon Fabric/Sb Mixtures

The work began with the preparation of antimony (Sb) particles, which entailed mixing Sb₂O₃ particles with small activated carbon (AC) particles using ball milling. By heating the resulting mixture in a sealed autoclave and heating the mixture to 950° C., antimony was obtained from the oxide by a carbothermal reduction: 2Sb₂O₃+3C→4Sb+3CO₂. The Sb particles produced typically resided in pores of AC, which could be recovered by breaking up the AC particles with ball-milling.

The Sb particles, with or without chopped carbon fibers, were immersed in a solution of copper acetate in water. Water was subsequently removed and consequently the dried particles were coated with a thin layer of copper acetate. These metal precursor-coated Sb particles alone, or with metal precursor-coated carbon fibers, were then exposed to a heat treatment in a reducing atmosphere of H₂ and Ar gas according to a desired temperature profile. This profile typically included from room temperature to a reduction temperature of approximately 300° C.-600° C. (for reduction of copper acetate to Cu nano coating). The temperature was continued to rise to a final temperature of 526° C.-620° C. for 1-3 hours. The system was allowed to cool down to 520° C. for 1 hour and then cooled down naturally to room temperature, resulting in copper metal catalyst-assisted growth of Sb nanowires from Sb particles. Again, the presence of carbon fibers leads to the growth of a larger number of smaller-diameter Sb nanowires.

### EXAMPLE 4

### Gold-Assisted Growth of Ge Nanowires From Ge Particles

Ge particles (platelets of 1.2 μm long and 0.25 μm thick) and carbon black (CB) particles were coated with a thin layer of Au using sputtering deposition up to a thickness of 1.5-5.6 nm. The Ge—Au system is known to have a eutectic point at Te=361° C. and Ce=28% Ge. Samples of a powder mass of Au-coated Ge particles, with or without CB, were heated to 600° C. and allowed to stay at 600° C. for 2 hours and then cooled down to 370° C. and maintained at 370° C. for 1 hour. The material systems were then cooled to 355° C. for 2 hours and then naturally cooled to room temperature after switching off the power to the oven.

Gold catalyst-assisted growth of Ge nanowires from Ge particles occurred during the subsequent cooling process. The diameter of Ge nanowires produced without the presence of CB was in the range from 42 nm to 67 nm. With assistance from CB, the diameter of Ge nanowires was from 26 to 38 nm. Nanowires having a smaller diameter are more high-rate capable, being able to deliver a higher specific capacity when the lithium-ion battery is charged or discharged.

### EXAMPLE 5

### Zinc-Assisted Growth of Sn Nanowires from Sn Particles With or Without CNF/Graphene Sheets

Tin particles, graphene sheets, and CNFs were coated with a thin layer of Zn using a physical vapor deposition procedure for up to a thickness of 1.1-3.5 nm. The Sn—Zn system is known to have a eutectic point at Te=198.5° C. and Ce=85.1% Sn. A powder mass of Zn-coated Sn particles (3.5 μm in diameter), with or without graphene sheets/CNFs, were heated to 220° C. and allowed to stay at220° C. for 1 hour and then cooled down to 200° C. and maintained at 200° C. for 30 minutes. The material system was then naturally cooled to room temperature after switching off the power to the oven. The Sn nanowires grown from Sn particles without the assistance from graphene sheets/CNFs were found to have diameters in the approximate range of 25-65 nm. In the presence of graphene sheets/CNFs, the Sn nanowires having a diameter range of 13-20 nm and 15-25 nm, respectively.

### EXAMPLE 6

### Removal of Carbon Filaments from the Ge Nanowire/CNT Hybrid Materials

A certain amount of the Ge nanowire/CNT hybrid materials was poured into a water bath and ultrasonicated for 2 hours. The resulting mixture mass was centrifuged for 30 minutes to separate Ge nanowire powders from CNTs.

### EXAMPLE 7

### Lithium-Ion Batteries Featuring Ge and Sn Nanowires as an Anode Active Material

For electrochemical testing, several types of anodes and cathodes were prepared. For instance, a layer-type of anode was prepared by simply coating slurry of Ge or Sn nanowires, conductive additives, and a binder resin to form an anode layer against a sheet of Cu foil (as an anode current collector).

For instance, the working electrodes were prepared by mixing 75 wt. % active material (Ge or Sn nanowires), 17 wt. % acetylene black (Super-P, as a conductive additive), and 8 wt. % polyvinylidene fluoride (PVDF) as a binder dissolved in N-methyl-2-pyrrolidinoe (NMP). After coating the slurries on Cu foil, the electrodes were dried at 120° C. in vacuum for 2 h to remove the solvent before a compression treatment. When graphene sheets or expanded graphite flakes were included, the amount of acetylene black was reduced accordingly.

Then, the electrodes were cut into a disk ϕ=12 mm) and dried at 100° C. for 24 h in vacuum. Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). Various anode material compositions were evaluated. The cell assembly was performed in an argon-filled glove-box. The CV measurements were carried out using a CH-6 electrochemical workstation at a scanning rate of 1 mV/s. The electrochemical performance of Si nanowires was also evaluated by galvanostatic charge/discharge cycling at a current density of 50-1,000 mA/g, using a LAND electrochemical workstation. Full-cell pouch configurations using lithium iron phosphate and lithium cobalt oxide cathodes were also prepared and tested.

It may be noted that the lithium-ion battery industry has adopted a nomenclature system for a charge or discharge rate. For instance, 1 C charging means completing charging procedure in 1 hour and 2 C charging means completing charging procedure in ½ hours (30 minute). A 10 C charging rate means charging completion in 1/10 hours (6 minutes).

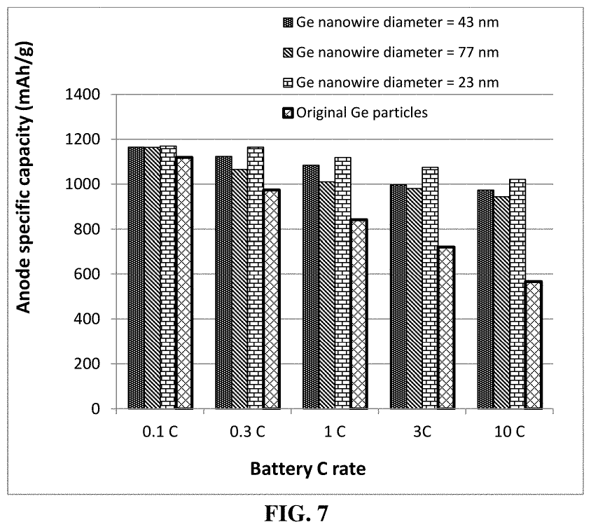

Some experimental results are summarized in FIG. 7, which indicates that the composite anode containing 75% by wt. of Ge nanowires having a diameter of 23 nm is capable of delivering a lithium storage capacity of 1,170 mAh/g (based on the total electrode composite weight, not just the Ge weight) at 0.1 C rate and 1,022 mAh/g at 10 C rate. These small-diameter Ge nanowires were obtained with the assistance of graphene sheets. The composite anode containing 75% by wt. of Ge nanowires having a diameter of 43 nm is capable of delivering a lithium storage capacity of 1,166 mAh/g at 0.1 C rate and 975 mAh/g at 10 C rate. At this ultra-high rate of 10 C., one can complete the charge or discharge in 1/10 hours or 6 minutes. In contrast, the lithium battery cell featuring original Ge particles as the anode active material exhibits a specific capacity of 1,120 mAh/g at 0.1 C rate, but the specific capacity drops to 567 mAh/g at a 10 C charge rate. This is a tremendous accomplishment. Imagine you can totally recharge your smart phone in 6 minutes. As of now, it typically takes 2 hours. As a point of reference, natural graphite, the most commonly used anode active material, is capable of storing lithium up to 370 mAh/g at 0.1 C rate, but only 250 mAh/g at 10 C rate.

Similar tends were observed for lithium-ion batteries that contain other types of semiconductor nanowires herein produced as the primary anode active material. These observations have demonstrated that smaller-diameter nanowires are significantly more high-rate capable in a lithium-ion battery. The disclosure provides a cost-effective process for producing a wide variety of semiconductor nanowires.

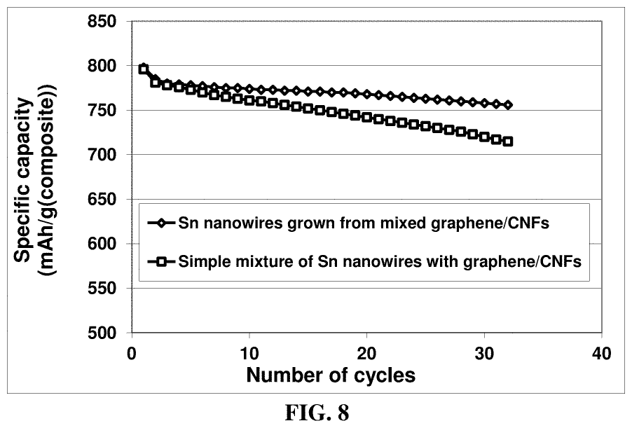

FIG. 8 shows the charge/discharge cycling behaviors of two lithium-ion cells, one featuring Sn nanowires grown in situ inside graphene/CNF-protected particulates as the anode active material and the other containing a simple mixture of Sn nanowires and graphene sheets/CNFs. The latter anode was obtained by preparing Ge nanowires produced without the presence of graphene sheets/CNFs but later added with an equal amount of graphene sheets/CNFs as a conductive additive. The results have demonstrated the superior cycling behavior of a lithium-ion battery having nanowires grown in situ inside graphene/CNFs-encapsulated particulates. These nanowires are significantly longer and smaller in diameter. Many of these semiconductor nanowires are curly in shape having a radius of curvature that can be varied from 100 nm to 10 μm.

We claim:

1. A process for producing a carbon/semiconductor nanowire hybrid material composition, said process comprising:
(A) preparing a catalyst metal-coated mixture mass, which includes (i) mixing carbon filaments, having a diameter from 10 nm to 30 μm, with semiconductor particles, having a particle diameter from 50 nm to 50 μm, to form a mixture and (ii) depositing a catalytic metal, in the form of nano particles having a size from 1 nm to 100 nm or a coating having a thickness from 1 nm to 100 nm, onto surfaces of said carbon filaments and/or surfaces of said semiconductor particles to form catalytic metal-coated semiconductor particles and/or catalytic metal-coated carbon filaments, wherein said semiconductor material is selected from Si, Ga, In, Ge, Sn, Pb, P, As, Sb, Bi, Te, a compound thereof, an alloy thereof, or a combination thereof; and
(B) exposing said catalyst metal-coated mixture mass to a high temperature environment, from 100° C. to 2,500° C., for a period of time sufficient to enable a catalytic metal-assisted growth of multiple semiconductor nanowires, having a diameter or thickness from 2 nm to 100 nm, from said semiconductor particles to form said carbon-semiconductor nanowire hybrid material composition.

2. The process of claim 1, wherein said carbon filaments are selected from carbon nanotubes, carbon nanofibers, graphite nanofibers, graphene fibers, carbon fibers, graphite fibers, carbon black chains, or a combination thereof.

3. The process of claim 1, wherein said carbon filaments have a diameter from 10 nm to 200 nm or a specific surface area from 50 to 1,500 m²/g.

4. The process of claim 1, wherein said carbon filaments form a fabric, nonwoven, paper, membrane, or foam structure having pores and said catalytic metal-coated semiconductor particles reside in said pores and wherein said catalytic metal nano particles or coating is deposited on pore wall surfaces.

5. The process of claim 1, wherein said catalytic metal is selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof, wherein said catalytic metal is different than said semiconductor material.

6. The process of claim 1, wherein said step of depositing a catalytic metal includes (a) dissolving or dispersing a catalytic metal precursor in a liquid to form a precursor solution, (b) bringing said precursor solution in contact with surfaces of said carbon filaments and/or surfaces of said semiconductor particles, (c) removing said liquid; and (d) chemically or thermally converting said catalytic metal precursor to said catalytic metal coating or nano particles.

7. The process of claim 6, wherein said step (d) of chemically or thermally converting said catalytic metal precursor is conducted concurrently with the procedure (B) of exposing said catalyst metal-coated mixture mass to a high temperature environment.

8. The process of claim 6, wherein said catalytic metal precursor is a salt or organo-metal molecule of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

9. The process of claim 6, wherein said catalytic metal precursor is selected from a nitrate, acetate, sulfate, phosphate, hydroxide, or carboxylate of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

10. The process of claim 6, wherein said catalytic metal precursor is selected from a nitrate, acetate, sulfate, phosphate, hydroxide, or carboxylate of a transition metal.

11. The process of claim 6, wherein said catalytic metal precursor is selected from copper nitrate, nickel nitrate, cobalt nitrate, manganese nitrate, iron nitrate, titanium nitrate, aluminum nitrate, copper acetate, nickel acetate, cobalt acetate, manganese acetate, iron acetate, titanium acetate, aluminum acetate, copper sulfate, nickel sulfate, cobalt sulfate, manganese sulfate, iron sulfate, titanium sulfate, aluminum sulfate, copper phosphate, nickel phosphate, cobalt phosphate, manganese phosphate, iron phosphate, titanium phosphate, aluminum phosphate, copper hydroxide, nickel hydroxide, cobalt hydroxide, manganese hydroxide, iron hydroxide, titanium hydroxide, aluminum hydroxide, copper carboxylate, nickel carboxylate, cobalt carboxylate, manganese carboxylate, iron carboxylate, titanium carboxylate, aluminum carboxylate, or a combination thereof.

12. The process of claim 1, wherein said step of depositing a catalytic metal is conducted by a procedure of physical vapor deposition, chemical vapor deposition, sputtering, plasma deposition, laser ablation, plasma spraying, ultrasonic spraying, printing, electrochemical deposition, electrode plating, electrodeless plating, chemical plating, ball milling, or a combination thereof.

13. The process of claim 1, wherein said procedure of exposing said catalyst metal-coated semiconductor material to a high temperature environment is conducted in a protective atmosphere of an inert gas, nitrogen gas, hydrogen gas, a mixture thereof, or in a vacuum.

14. The process of claim 1, wherein said semiconductor material and said catalytic metal form an eutectic point and said procedure of exposing said catalyst metal-coated semiconductor material to a high temperature environment includes exposing said material to a temperature equal to or higher than said eutectic point for a desired period of time and then bringing said material to a temperature below said eutectic point.

15. The process of claim 14, wherein said exposure temperature is higher than said eutectic temperature by 0.5 -500 degrees centigrade.

16. The process of claim 1, wherein said step of mixing the semiconductor particles and carbon filaments is conducted by liquid solution mixing, homogenizer mixing, high shearing mixing, wet milling, air milling, or ball-milling.

17. The process of claim 1, wherein said mixing of said carbon filaments with said semiconductor particles is conducted after surfaces of said carbon filaments and/or said semiconductor particles are deposited with said catalytic metal.

18. The process of claim 1, further comprising a procedure of separating said carbon filaments from said semiconductor nanowires.

19. The process of claim 1, further comprising a procedure of removing said catalytic metal from said carbon filaments-semiconductor nanowire hybrid material composition.

20. The process of claim 1, further comprising a procedure of mixing said carbon/semiconductor nanowire hybrid composition with a carbonaceous or graphitic material as a conductive additive and an optional binder material to form an electrode layer, wherein said carbonaceous or graphitic material is selected from a chemical vapor deposition carbon, physical vapor deposition carbon, amorphous carbon, chemical vapor infiltration carbon, polymeric carbon or carbonized resin, pitch-derived carbon, natural graphite, artificial graphite, mesophase carbon, mesophase pitch, mesocarbon microbead, soft carbon, hard carbon, coke, or a combination thereof.

21. A carbon-semiconductor nanowire hybrid material composition produced by the process of claim 1.

22. A battery electrode containing a carbon-semiconductor nanowire hybrid material composition produced by the process of claim 1.

23. A lithium battery containing carbon-semiconductor nanowire hybrid material composition produced by the process of claim 1 as an anode active material.
